(19) United States
(12) Patent Application Publication
(10) Pub. No.: US 2025/0113417 A1
(43) Pub. Date: Apr. 3, 2025

(54) LED Light Bulb with Adjustable Wattage and Brightness

(71) Applicant: Lalit J. Savla, San Diego, CA (US)

(72) Inventor: Lalit J. Savla, San Diego, CA (US)

(21) Appl. No.: 18/969,221

(22) Filed: Dec. 4, 2024

Related U.S. Application Data
(60) Provisional application No. 63/605,786, filed on Dec. 4, 2023.

(51) Int. Cl. H05B 45/10; H05B 47/19

(52) U.S. Cl. CPC H05B 45/10; H05B 47/19

(57) ABSTRACT

LED light bulbs are sold in the marketplace with only one wattage rating. They are sold as incandescent light bulb equivalent of 40 W, 60 W, 75 W or 100 W brightness rating. This invention can combine all four different brightness level bulbs into a single LED light bulb and the brightness level can be selected by consumer using switches located on the body of the light bulb. This works with dimmable or non-dimmable LED light bulbs. Also, an added advantage of using the LED light bulb at lower than rated wattage increases the operating life significantly and saves energy cost since it produces more light per watt.

### RELATED APPLICATIONS

This application claims the benefit of U.S. Provisional patent application Ser. No. 63/605,786 filed Dec. 4, 2023, entitled “LED Light Bulb with Adjustable Wattage and Brightness” which is hereby incorporated herein by reference in its entirety.

### FIELD

This invention relates to electric LED light bulbs and light dimmers.

### BACKGROUND

U.S. Pat. No. 11,839,000B1 by Savla entitled “Light Dimmer for Non-Dimmable LED Light Bulbs”, discloses the method to dim the non-dimmable and dimmable LED light bulbs externally by using a network of capacitors and switches with zero power loss circuit. It does not explain how to use the said dimmer circuit inside the LED light bulb. The proposed application specifically addresses the use of the said invention for use inside the body of a LED light bulb to make each individual LED light bulb dimmable and therefore multi wattage.

### SUMMARY

Typically, light bulbs in the market are sold with fixed wattage. Traditionally, incandescent light bulbs were sold in the 40-, 60-, 75- and 100-watts range. To replace the corresponding brightness level, LED light bulbs are sold in the approximately 5-, 7-, 10- and 13-watts range. If one LED light bulb can satisfy two or more wattage (brightness) requirements, it would make it efficient and economical for manufacturer, stocker, and consumer. Also, a consumer could use the same light bulb at a lower brightness level as a night lamp. This invention solves this problem by using a light dimmer circuit consisting of network of capacitors and switches with zero power loss as described in the U.S. Pat. No. 11,839,000B1 by Savla and place it inside the body of a dimmable or non-dimmable LED light bulb. Consumer also benefits by savings in energy cost and extended light bulb life by using a LED light bulb at reduced wattage and brightness level. The bulb wattage (brightness) is adjusted by setting small switches located inside the light bulb with control access from outside of the light bulb. This dimmer circuit works with dimmable or non-dimmable LED light bulbs. For example, one small switch inside the light bulb with control access from the outside of the bulb can switch between full brightness (full wattage) to lower brightness (lower wattage) serving as a night lamp or lower wattage light bulb. Similarly, for example, two or more switches inside the LED light bulb can adjust wattage of a 7-watt LED light bulb (60 W incandescent equivalent) from a fraction of a watt (dim light) to 7 watts (full brightness) in multiple steps.

### BRIEF DESCRIPTION OF THE DRAWINGS

FIG. 1A illustrates the internal structure of a typical E26 base LED light bulb and corresponding schematic representation.

FIG. 1B illustrates the internal structure of an economically made E26 base non-dimmable LED light bulb and corresponding schematic representation.

FIG. 2A illustrates the internal structure of a modified E26 base non dimmable LED light bulb with dual adjustable wattage (brightness).

FIG. 2B illustrates the internal structure of a proposed E26 base non dimmable LED light bulb with dual adjustable wattage (brightness) by using the back side of existing substrate 4 for capacitors as parts of the dimming circuit.

FIG. 3 shows the table of experimental data of a modified non-dimmable LED light bulb per FIG. 2A.

FIG. 4A illustrates the internal structure and corresponding schematic representation of a modified E26 base non dimmable LED light bulb with up to 8 levels of wattage (brightness) settings by adding substrate 3A for capacitors network.

FIG. 4B illustrates the internal structure and corresponding schematic representation of a proposed E26 base LED light bulb with up to 8 levels of wattage (brightness) settings by using backside of substrate 4 for capacitors network.

FIG. 4C illustrates the internal structure and corresponding schematic representation of proposed E26 base LED light bulb with up to 8 levels of wattage (brightness) settings by using additional substrates 3A, 3B and 3C to accommodate high value capacitors.

FIG. 5 shows the test results of a modified LED light bulb with a dimming circuit using seven 1 uf capacitors connected with switch network S2-S4 in binary weighted manner per FIG. 4A. Switch S1 is used as a bypass switch.

### DETAILED DESCRIPTION

U.S. Pat. No. 11,839,000B1 by Savla entitled “Light Dimmer for Non-Dimmable LED Light Bulbs” describes the novel method to use the dimmer circuit consisting of only capacitors and switches to dim the non-dimmable LED light bulbs. As explained in the said patent, there is no power loss in the dimming circuit since it does not use any resistive or active components. Therefore, by integrating this zero-power loss dimmer circuit within the body of a LED light bulb, it would not generate any additional heat inside the body of a light bulb. This would not require any major thermal design changes to the LED light bulb, which is a major cost factor.

The following figures describe infernal structure of LED light bulbs and the methods to integrate capacitor based zero loss dimmer circuit inside a most used size E26 base non dimmable LED light bulb or dimmable LED light bulb. Similar techniques can be used to integrate this dimmer circuit inside any other base style of LED light bulb.

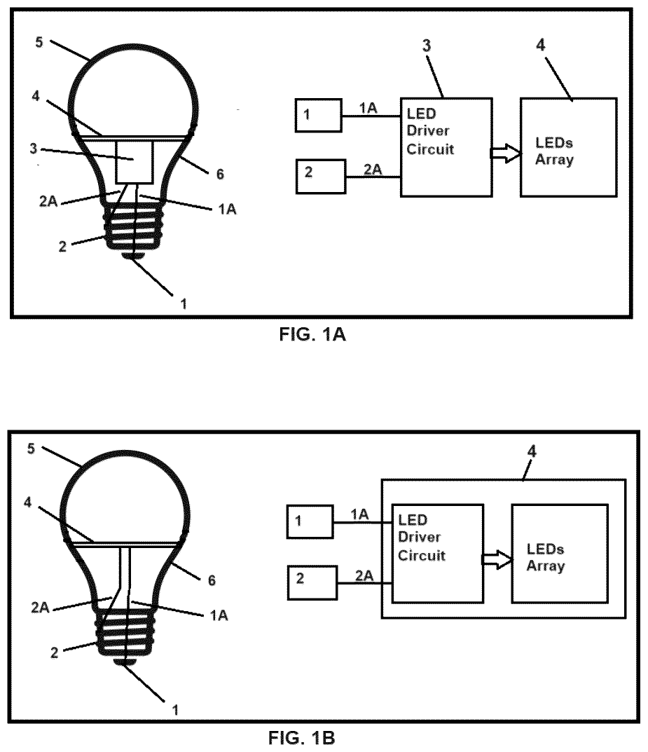

FIG. 1A shows the typical internal structure and corresponding schematic representation of an LED light bulb. Common household bulbs use size E26 base which consist of central connection 1 and side connection 2 which are powered by AC voltage source from the utility when the light bulb is plugged in the corresponding AC powered light bulb socket. 1 and 2 are connected internally to LED driver circuit 3 via wires 1A and 2A respectively. LED driver circuit may be on an independent substrate 3 or sometimes included with substrate 4 which consists of LEDs array. Some economically made LED light bulbs have simple drive circuits and use the same substrate 4 for LED drive circuit and LEDs array as shown in FIG. 1B. Generally, they are sold as non-dimmable LED light bulbs. Some use sophisticated drive circuits by adding substrate 3 which are sold as dimmable LED light bulbs. The outer body 5 of the LED light bulb is transparent or translucent above substrate 4 area so that light produced by LED array on top of the substrate can illuminate the surrounding outside of the bulb. Generally, the light bulb area under substrate 4 is surrounded by opaque enclosure 6.

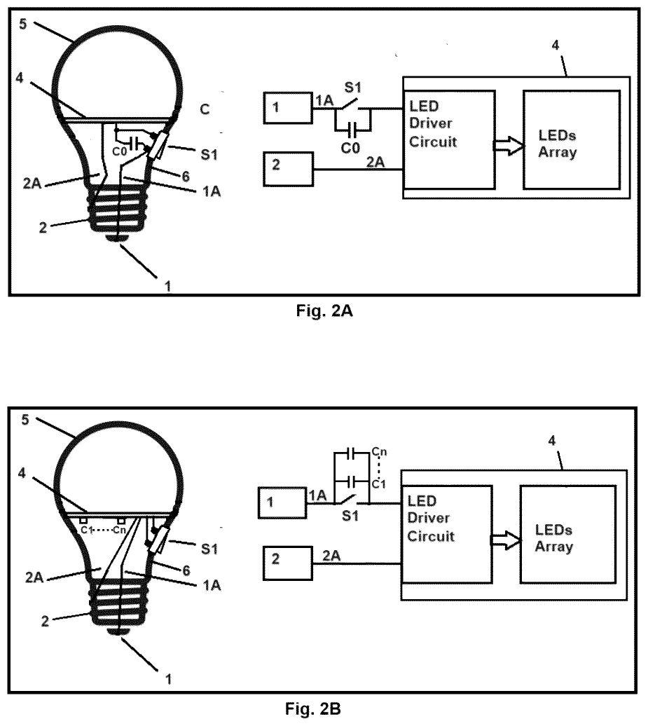

FIG. 2A illustrates the internal structure and corresponding schematic representation of a modified non dimmable LED light bulb of FIG. 1B which can selectively produce two brightness levels or wattages. As shown in the figure, a bypass switch S1 and a capacitor C0 are added between terminal 1 of the E26 light bulb base and LED Driver Circuit on substrate 4. Bypass Switch S1 can selectively bypass capacitor C0. Switch S1 is mounted on the perimeter of light bulb enclosure 6 and can be turned On or Off externally. When the bypass switch S1 is in the ON position, the light bulb is functionally the same as the light bulb of FIG. 1B and produces full brightness when connected to the utility AC voltage source. When the bypass switch S1 is in the OFF position, AC current must pass though capacitor C0. Therefore, the current available to the LED Driver Circuit and LEDs array is limited by the value of C0. Depending on the value of C0, the LED light bulb can be used as a dual wattage light bulb with high value capacitor C0 or as a night lamp bulb with low value capacitor C0. For example, 40 W and 60 W incandescent equivalent LED light bulbs are 5 and 7 watts respectively. Therefore, a 7 W LED light bulb (60 W equivalent) can be made to produce 5 W (40 W equivalent) LED light bulb when S1 is in OFF position with the value of capacitor C0 in the range of 7 uf to 10 uf depending on the brand of a light bulb in the experiment. With C0 in the range of 0.2 uf to 1 uf, it can be used as a night lamp (low brightness) when S1 is on OFF position. Please note that the capacitors should be non-polarized or bipolar type.

This dimmer circuit based on a capacitor or network of capacitors would not have been practical for use with incandescent light bulbs because of the high current requirements to operate incandescent light bulbs. However, with the advent of LED light bulbs, this dimmer circuit is practical because of very low current requirements to operate a non-dimmable or dimmable LED light bulb. Since the internal LED Driver circuit is proprietary to each different brand, bench testing was conducted, and it showed that some LED bulb brands (mostly non-dimmable) were found to start operating under 2 ma and some brands (mostly dimmable type) would require over 5 ma before they start operating. With C0 value of 0.1 uf, the impedance (assuming 120V mains line frequency of 60 Hz) would be Xc=1/(2πfc)=26522 ohms. Therefore, the maximum current available to the LED bulb would be 120V/26522=4.5 ma, assuming the LED bulb is short. However, actual current will depend on the internal driver circuit structure of a specific LED bulb brand. In general, all the brands available at the time of testing worked with this dimmer circuit.

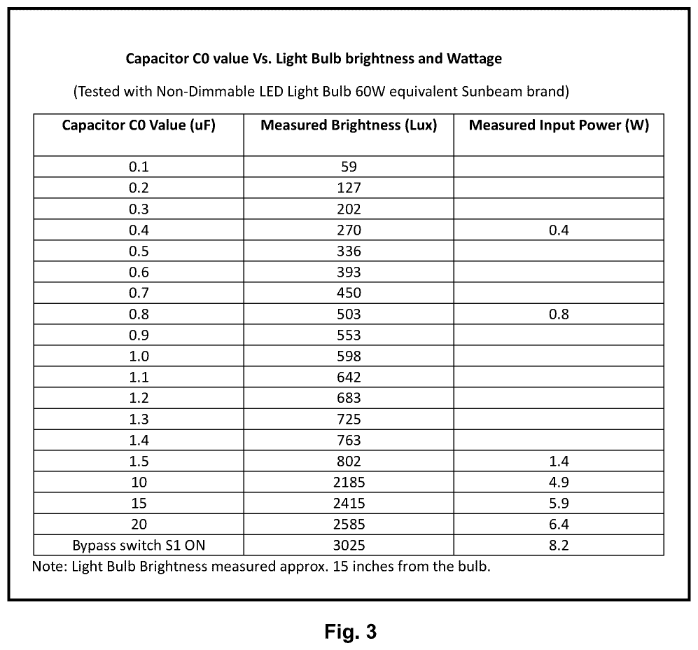

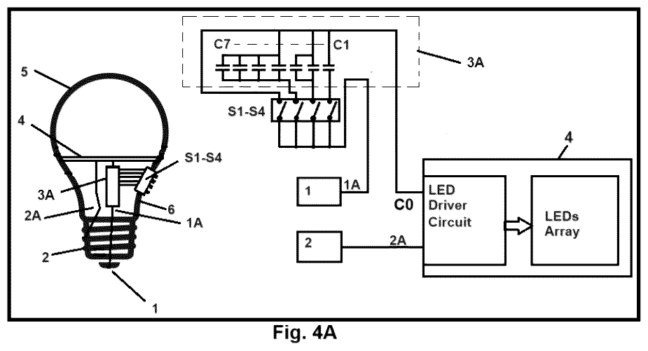

FIG. 3 table shows the light bulb brightness and input power Vs. capacitor value of a modified non-dimmable LED lightbulb per FIG. 2A. It was found that this technique works with most of the LED light bulbs available in the market, dimmable or non-dimmable type. Therefore, this method of converting any LED light bulb from single wattage to multi wattage light bulb is feasible. For example, as shown in the table, when the bypass switch is in ON position, the LED light bulb is fully ON and produces 3025 Lux of brightness with 8.2 Watts of input power. Since the test bulb is rated as 60 W incandescent equivalent, corresponding 40 W equivalent should give out brightness of (40/60)×3025=2016 Lux. Please note that per the test data, with C0 value of 10 uf, the light produces 2185 Lux of brightness and 4.9 W input power (with bypass switch S1 in OFF position) which is greater than expected brightness value at lower-than-expected wattage input of (40/60×8.2)=5.42 Watts. This proves that the LED light bulb will be more efficient at reduced operating wattage level. It will save energy cost and extend the life of the LED light bulb significantly.

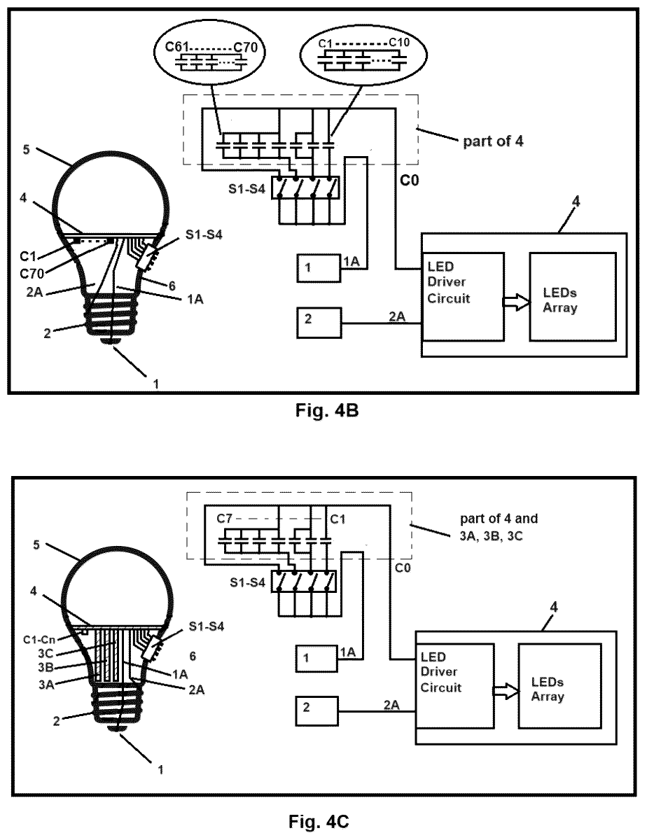

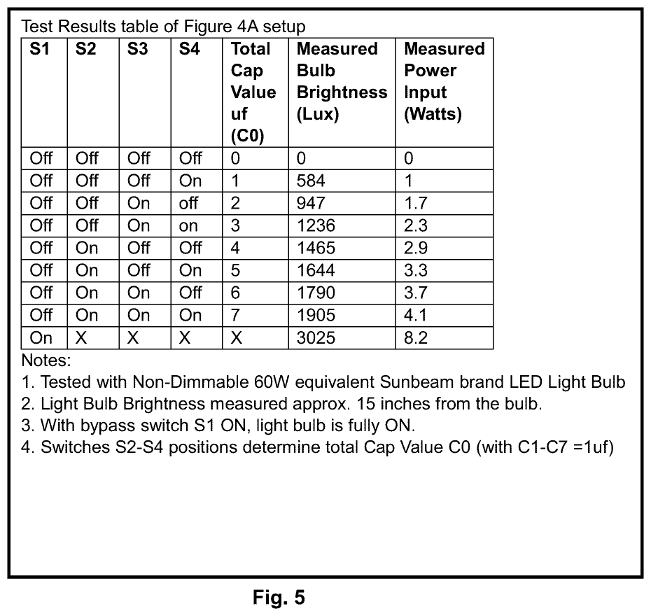

FIG. 4A illustrates the internal structure and corresponding schematic representation of a modified non-dimmable LED light bulb of FIG. 1B which can selectively produce eight brightness levels or wattages. As shown in the figure, switches S1-S4 and capacitors C1-C7 are connected between terminal 1 of the light bulb E26 base and LED driver circuit. C1-C7 are part of a new substrate 3A. Optionally, these capacitors can be made part of substrate 4 to reduce cost. S1-S4 are mounted under the enclosure surface 6 of the light bulb with switching access from outside. When the bypass switch S1 (which is connected to the common of the capacitors) is in closed position, it bypasses all capacitors C1-C7, and the light bulb will turn on with full brightness when connected to the utility AC voltage source. When S1 is in OFF position, current must pass through capacitors C1-C7 depending on the switches S2-S4 positions and produce brightness level and wattage per the table in FIG. 5. Please note that S2-S4 and C1-C7 are connected in a binary weighted manner. In this example C1-C7 are each 1 uf value.

Each capacitor value can be changed to a higher value to produce higher wattage and brightness. Please note that, with S1 in ON position, the light bulb is fully on with brightness measured at 3025 LUX and input power of 8.2 Watts compared to 1905 LUX and input power of 4.1 Watts with 7 uf capacitance in the circuit. This again indicates that the LED light bulb is operating much more efficiently at lower wattage operation. This would be the added advantage of saving energy and improved light bulb life.

High value, high voltage non polarized capacitors are expensive and big in size. It would not be practical to fit these large capacitors inside the LED light bulb. Bipolar, high voltage electrolytic capacitors are small in size which can be used, and they were found to produce satisfactory results. However, they may not be cost effective. To solve this problem, low value economically priced SMD (surface mount) capacitors can be connected in parallel. FIGS. 4B, 4C depict methods to attain high value capacitance by using small SMD capacitors and ganging them in parallel. For example, in FIG. 48, C1-C10 form a one capacitor and connects to S4. The back side of substrate 4 with a diameter of 1.75″ can accommodate over 150 size 1206 SMD 0.1 uf 200V rated capacitors resulting in the range of 0.1 uf to 15 uf network of capacitance In FIG. 4B. Also, by adding substrates 3A, 3B, 3C as shown in FIG. 4C, or more as required. Each substrate can contain many small and economical high voltage surface mount 0.1 uf non polarized capacitors connected in parallel to form high value capacitance. The substrates 3A, 3B, 3C are connected to substrate 4. Switch S1-S4 are also connected to substrate 4. Therefore, large variations of LED bulb wattages and brightness can be obtained by connecting the capacitor network of 3A, 3B, 3C substrate to switches S1-S4. By adding more switches and capacitors, brightness and wattage range can also be increased. For example, with 8 switches, 128 distinct brightness levels and wattages can be attained since one switch is used as a bypass switch.

The foregoing discussion was concentrated on the use of mechanical switches to connect a network of capacitors to produce a loss less light dimmer for multi wattage or adjustable brightness light bulb. Please note that the mechanical switches can be replaced by a network of solid-state switches which can be controlled remotely via wireless method to connect a network of capacitors inside the bulb to change brightness or wattage of a light bulb.

I claim:

1. A non-dimmable LED lightbulb or dimmable LED lightbulb consisting of one or more capacitors connected in parallel with equivalent capacitor value of C0 connected across a bypass switch terminals mounted on the outer body of the LED light bulb; bypass switch terminals connected in series between the said LED light bulb base terminal (for example E26 base is most common) and the LED Driver Circuit of the said LED lightbulb, for the purpose of adjusting the LED Light bulb brightness level or wattage dependent on the value of C0 when the bypass switch is in the open position; LED light bulb turns fully ON when bypass switch in the closed position.

2. A non-dimmable LED lightbulb or dimmable LED lightbulb consisting of DIP switches (or equivalent) mounted on the outer body of the said LED lightbulb and connected to a capacitors network in a binary weighted manner to form a zero loss dimming circuit which is connected in series between the base terminal (for example E26 base) and LED Driver Circuit of the said LED Light bulb; one of the switch is used as a bypass switch to bypass capacitor network; effective capacitance C0 seen by the said LED light bulb's LED Drive Circuit is dictated by the said DIP switches settings (for example 3-bit DIP switch can produce 8 distinct C0 values), for the purpose of adjusting the LED Light bulb brightness or wattage when the bypass switch is in open position; LED light bulb turns fully ON when bypass switch in the closed position.

3. The LED lightbulb of claim 2, wherein each single capacitor is replaced by many smaller and economical high voltage SMD capacitors connected in parallel to form higher value effective capacitance C0 seen by the LED lightbulb Driver Circuit.

4. The LED lightbulb of claim 2, wherein said switches are replaced by solid state switch network which can be installed inside the light bulb body and controlled remotely via Bluetooth or other wireless methods to control LED light bulb brightness or wattage.
